(19) United States
(12) Patent Application Publication
(10) Pub. No.: US 2026/0236174 A1
(43) Pub. Date: Aug. 13, 2026

(54) READ DISTURB SCAN WITH BIN CALIBRATION

(71) Applicant: Micron Technology, Inc., Boise, ID (US)

(72) Inventors: Lei Lin, Fremont, CA (US); Christina Papagianni, San Jose, CA (US); Jianmin Huang, San Carlos, CA (US)

(21) Appl. No.: 19/048,409

(22) Filed: Feb. 7, 2025

(51) Int. Cl. G06F 3/06

(52) U.S. Cl. CPC G06F 3/0614; G06F 3/0653; G06F 3/0659; G06F 3/0679

(57) ABSTRACT

This disclosure is directed to a system for performing read error handling. The system tracks read count and temperature data for a portion of a memory device and, in response to determining that the read count for the portion transgresses a threshold, compares a current bin assignment that specifies a first set of read threshold offsets for reading data from the portion of the memory device with a target bin specified in a predefined table of bin assignments. The predefined table of bin assignments associates read counts and temperatures with corresponding target bin assignments. The system selectively performs bin calibration to selectively adjust a read threshold voltage offset to read data from the portion in response to comparing of the current bin assignment and the target bin and performs a read disturb handling (RDH) operation on the portion of the memory device using the selectively adjusted read threshold voltage offset.

### TECHNICAL FIELD

Examples of the disclosure relate generally to memory sub-systems and, more specifically, to performing read disturb handling (RDH) operations.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various examples of the disclosure. The drawings, however, should not be taken to limit the disclosure to the specific examples, but are for explanation and understanding only.

FIG. 1 is a block diagram illustrating an example computing system that includes a memory sub-system, in accordance with some examples.

FIG. 2 illustrates a block family error avoidance (BFEA) table, in accordance with some examples.

FIG. 3 illustrates a diagram of a table of target bins based on read count and temperature, in accordance with some examples.

FIG. 4 illustrates a flowchart of operations performed using a RDH component, in accordance with some examples.

FIG. 5 illustrates a diagram of operations performed using a RDH component, in accordance with some examples.

FIG. 6 illustrates a diagram of operations performed using a RDH component, in accordance with some examples.

FIG. 7 is a block diagram of an example computer system, according to some examples.

### DETAILED DESCRIPTION

The present disclosure is directed to a system including a memory device and a processing device, operatively coupled to the memory device, configured to perform operations that improve RDH operations through intelligent bin calibration. The system does this by tracking read counts and temperature data for blocks (or other portions) in the memory device. Specifically, the disclosed processing device maintains read counts and temperature data, and when a read count threshold is reached, the system selectively performs intelligent bin calibration by comparing the current bin assignment with target bins specified in a predefined table prior to performing RDH operations (e.g., prior to performing read disturb scan operations and/or refresh operations). The predefined table associates different read counts and temperature combinations with optimal bin assignments, including both conservative high temperature data retention (HTDR) bins and aggressive every page read disturb (EPRD) bins. This approach enhances RDH operations (e.g., read disturb handling) precision while maintaining efficient operation by reducing unnecessary refresh operations, which can improve total bytes written (TBW) performance. This can significantly improve overall memory sub-system performance and reliability by ensuring optimal read threshold voltage offsets are used during read operations and RDH operations.

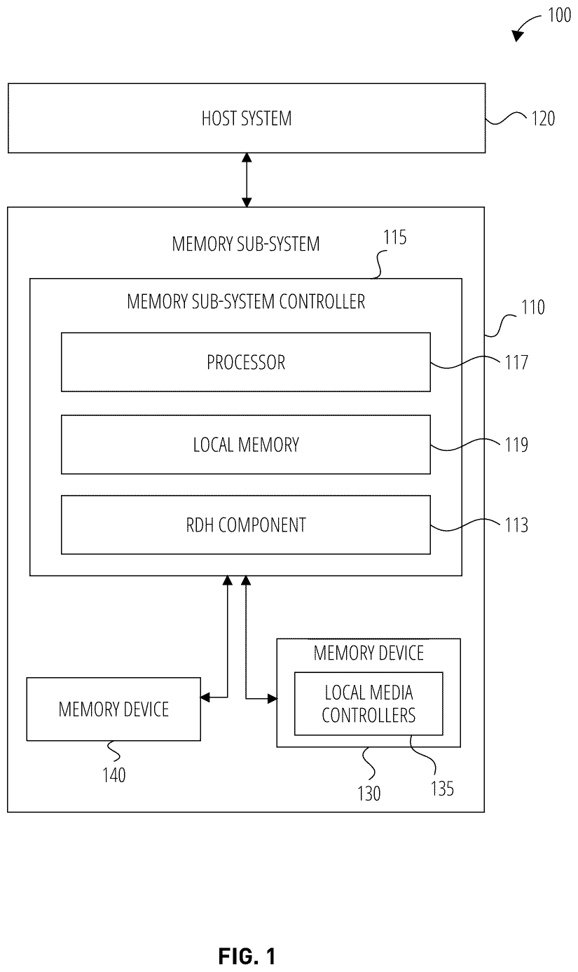

A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can send access requests to the memory sub-system, such as to store data at the memory sub-system and to read data from the memory sub-system.

The host system can send access requests (e.g., write command, read command, erase command) to the memory sub-system, such as to store data on a memory device at the memory sub-system, read data from the memory device on the memory sub-system, or write/read constructs (e.g., such as submission and completion queues) with respect to a memory device on the memory sub-system. The data to be read or written, as specified by a host request, is hereinafter referred to as “host data” or “user data.”

A host request can include logical address information (e.g., logical block address (LBA), namespace) for the host data, which is the location the host system associates with the host data and a particular zone in which to store or access the host data. The logical address information (e.g., LBA, namespace) can be part of metadata for the host data. Metadata can also include error handling data (e.g., error-correcting code (ECC) code word, parity code), data version (e.g., used to distinguish age of data written), valid bitmap (which LBAs or logical transfer units contain valid data), and so forth.

The memory sub-system can initiate media management operations, such as a write operation, on host data that is stored on a memory device. For example, firmware of the memory sub-system may re-write previously written host data from a location of a memory device to a new location as part of garbage collection (GC) management operations. The data that is rewritten, for example as initiated by the firmware, is hereinafter referred to as “GC data.” Examples of system data include, but are not limited to, system tables (e.g., logical-to-physical memory address mapping table, also referred to herein as a logical-to-physical (L2P) mapping table (referred to as an L2P table), data from logging, scratch pad data, and so forth).

A memory device can be a non-volatile memory device. A non-volatile memory device is a package of one or more die. Each die can be comprised of one or more planes. For some types of non-volatile memory devices (e.g., AND-type devices), each plane is comprised of a set of physical blocks. For some memory devices, blocks are the smallest area that can be erased. Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which are raw memory devices combined with a local embedded controller for memory management within the same memory device package. The memory device can be divided into one or more zones where each zone is associated with a different set of host data or user data or application.

Certain memory devices, such as NAND-type memory devices, include one or more blocks, (e.g., multiple blocks), with each of those blocks including multiple memory cells. For instance, a memory device can include multiple pages (stored across one or more word lines (WLs)), with each page including a subset of memory cells of the memory device. A threshold voltage (VT) of a memory cell (of a block) can be the voltage at which the floating gate (e.g., NAND transistor), implementing the memory cell, turns on and conducts (e.g., to a bit line coupled to the memory cell). Generally, writing data to such memory devices involves programming (by way of a program operation) the memory devices at the page level of a block, and erasing data from such memory devices involves erasing the memory devices at the block level (e.g., page level erasure of data is not possible).

In a three-dimensional (3D) NAND array, read disturb (RD) usually occurs during the complex interplay of different voltage levels applied during read operations. When reading data from a target WL, the memory controller applies a read voltage (Vread) to that specific WL while simultaneously applying higher pass voltages to all unselected WLs to ensure proper current sensing. The neighboring WLs immediately adjacent to the target WL receive an intermediate pass voltage (Vpass1), while all other unselected WLs receive an even higher pass voltage (Vpass) to ensure these cells remain turned on during the read operation. This voltage configuration creates two distinct types of RD effects in the memory array. During sequential reading across WLs in a block, known as every page RD, each WL experiences uniform bias stress from the high pass voltage. This stress can inadvertently program unselected cells, with erased cells being particularly vulnerable due to their higher potential difference. When hosts repeatedly read from specific WLs, known as single page read disturb, the lateral electric field between the target WL and its neighbor WLs generates hot electrons, with this effect being most pronounced when reading lower pages due to the voltage differential between the read level and neighboring pass voltages.

To manage these RD effects, conventional systems implement firmware algorithms that monitor read counts (RCs) at the virtual block (VB) level. When a VB reaches its RC threshold, the memory controller initiates a RD scan on WLs in a list of WLs. The list of WLs includes a predefined list of mandatory WLs, the neighbor WLs of the most recently read WL, and/or the most recently read WL itself. If this RD scan detects elevated error rates (e.g., if the raw bit error rate (RBER) transgresses an RBER threshold), the memory controller refreshes the VB by relocating data from the VB to a new VB.

BFEA is a system for managing read threshold voltage offsets in memory blocks by tracking charge loss over time. A block family includes a collection of VB or page ranges that are programmed within similar time or temperature windows, ensuring uniform behavior and consistent read offset usage throughout their lifespan. BFEA employs a bin system where newly programmed blocks start at BIN 0 and transition to higher bins as charge loss occurs over time. Each bin corresponds to specific read level offsets (e.g., read threshold offsets or voltage threshold offsets) that are optimized for best bit error rate (BER) performance. By identifying a block's appropriate bin, the system can apply the correct read offset to avoid read errors. The BFEA system performs bin scans in both foreground and background operations to maintain optimal read-levels for best read performance. Each bin has its own scan frequency to monitor and adjust for charge loss.

Conventional approaches to RD handling in 3D NAND memory systems suffer from significant inefficiencies due to their reliance on periodic BFEA bin calibration. When BFEA bin updates occur at fixed intervals, there can be substantial gaps between calibrations during which the bin assignments become misaligned with the actual memory conditions. For example, if a bin update occurred 20 hours ago, the system continues using that potentially outdated bin assignment even though the optimal bin may have changed significantly during that time period. This periodic calibration approach is particularly problematic during periods of heavy host read operations. When intense read activity occurs between scheduled bin updates, the system applies increasingly inappropriate read threshold offsets, leading to artificially elevated RBER. The misalignment between the current bin assignment and optimal bin levels becomes especially critical just before RD scans are triggered, often resulting in unnecessary refresh operations that could have been avoided with proper bin calibration.

The resource waste is evident in several ways. First, blocks may remain at an incorrect bin assignment, such as BIN 0, when they should be at BIN 1 or BIN 2 based on actual conditions. When RD scans are performed using these misaligned bins, they trigger unnecessary refresh operations, which involve reading data out from the original block, erasing it, and writing to a new block. This not only consumes power and processing resources but also directly impacts the TBW specification of the device. The impact is particularly severe in cases where only charge loss distribution is observed without significant RD induced charge gain impact. In these scenarios, the RD refresh operations are unnecessarily triggered solely because the periodic bin update schedule failed to maintain proper read threshold voltage offsets. This inefficient use of system resources can lead to premature TWB reduction.

The present disclosure addresses these inefficiencies by implementing an intelligent bin calibration system that dynamically adjusts read threshold voltage offsets based on actual read counts and temperature data, rather than relying solely on periodic updates. The system maintains a predefined table that associates different combinations of read counts and temperature data with optimal bin assignments, including both conservative HTDR bins and aggressive EPRD bins. When a read count threshold is reached, instead of performing complex and time-consuming bin adjustment operations requiring multiple reads, the disclosed techniques efficiently determine the optimal read threshold voltage offset by comparing the current bin assignment with the target bin specified in the predefined table. This intelligent calibration can be selectively performed at two points, such as before read disturb scan operations using conservative bins, and before refresh operations using aggressive bins. The disclosed techniques further reduce unnecessary refresh operations by implementing a verification step that performs a second read operation with a different bin calibration when needed. This approach ensures that refresh operations are only triggered when truly necessary, rather than being caused by bin misalignment. By maintaining optimal read threshold voltage offsets during certain operations, the disclosed techniques improve TBW performance while reducing operation latency and system resource consumption.

This intelligent approach eliminates the problems associated with periodic bin updates by ensuring proper bin alignment at important moments, particularly during heavy host read operations. The system can accurately determine whether observed errors are due to actual read disturb issues or simply the result of bin misalignment, thereby preventing unnecessary refresh operations and maintaining optimal system performance.

In some examples, a system includes a memory device and processing device that work together to manage read operations. In some examples, the processing device tracks read count and temperature data for portions of memory, and when the read count exceeds a threshold, the processing device compares the current bin assignment against target bins specified in a predefined table. Based on this comparison, the processing device can perform RDH operations, which in some cases include read disturb handling (RDH) operations on memory blocks or VBs. During these operations, the processing device conducts RD scans to determine if RBER exceed specified thresholds.

In some implementations, the processing device maintains a BFEA table containing bin assignments. The predefined table of bin assignments includes both conservative bin assignments based on HTDR characteristics and more aggressive bin assignments based on EPRD characteristics. The processing device can perform bin calibration operations at different points in the process. In some cases, the processing device uses conservative bin assignments before a read disturb scan operation, while in other cases it employs more aggressive bin assignments after the RD scan but before performing a refresh operation.

During RDH operations, the processing device may perform multiple read disturb scans. In some implementations, the processing device conducts a first RD scan using an initial calibrated bin assignment, followed by a second scan using a different calibrated bin assignment if the RBER from the first RD scan exceeds the threshold. The processing device adjusts the current bin assignment based on either conservative or aggressive bin assignments depending on the stage of operation. The bin calibration process involves comparing numerical bin values, where higher numerical values correspond to larger read threshold voltage offsets to compensate for increased charge loss over time. The processing device adjusts the read threshold voltage offset when the processing device determines that the current bin assignment is lower than the target bin specified in the predefined table.

These operations can be implemented in various memory configurations, including 3D NAND devices. The system can be implemented through machine-readable storage media containing instructions for executing these operations, or as a method of performing these steps to manage memory operations effectively.

Though various examples are described herein as being implemented with respect to a memory sub-system (e.g., a controller of the memory sub-system), some or all of the portions of an example can be implemented with respect to a host system, such as a software application or an operating system of the host system.

FIG. 1 illustrates an example computing system 100 that includes a memory sub-system 110, in accordance with some examples. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, a secure digital (SD) card, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some examples, the host system 120 is coupled to different types of memory sub-systems 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., a peripheral component interconnect express (PCIe) controller, serial advanced technology attachment (SATA) controller). The host system 120 uses the memory sub-system 110, for example, to write data to the memory sub-system 110 and read data from the memory sub-system 110.

The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory devices 130, 140 when the memory sub-system 110 is coupled with the host system 120 by the PCIe or CXL interface. The physical host interface can provide an interface for passing control, address, data, and other signals between the memory sub-system 110 and the host system 120.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a NAND type flash memory and write-in-place memory, such as a 3D cross-point memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional (2D) NAND and 3D NAND.

Each of the memory devices 130, 140 can include one or more arrays of memory cells. One type of memory cell, for example, single level cells (SLCs), can store one bit per cell. Other types of memory cells, such as multi-level cells (MLCs), tri-level cells (TLCs), quad-level cells (QLCs), and penta-level cells (PLCs), can store multiple bits per cell. In some examples, each of the memory devices 130, 140 can include one or more arrays of memory cells such as SLCs, MLCs, TLCs, QLCs, or any combination of such. In some examples, a particular memory device can include an SLC portion, and an MLC portion, a TLC portion, or a QLC portion of memory cells. The memory cells of the memory devices 130, 140 can be grouped as pages that can refer to a logical unit of the memory device used to store data. With some types of memory (e.g., NAND), pages can be grouped to form blocks or superblocks. As used herein, a block including SLCs can be referred to as a SLC block, a block including MLCs can be referred to as a MLC block, a block including TLCs can be referred to as a TLC block, and a block including QLCs can be referred to as a QLC block.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide-based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide-based RRAM (OxRAM), negative-or (NOR) flash memory, and electrically erasable programmable read-only memory (EEPROM).

A memory sub-system controller 115 (or controller 115 for simplicity) can communicate with the memory devices 130, 140 to perform operations such as reading data, writing data, or erasing data (e.g., performing GC operations) at the memory devices 130, 140 and other such operations. The memory sub-system controller 115 can include hardware such as one or more integrated circuits and/or discrete components, a buffer memory, or a combination thereof. The hardware can include digital circuitry with dedicated (e.g., hard-coded) logic to perform the operations described herein. The memory sub-system controller 115 can be a microcontroller, special purpose logic circuitry (e.g., a field programmable gate array (FPGA), an application specific integrated circuit (ASIC), and so forth), or other suitable processor.

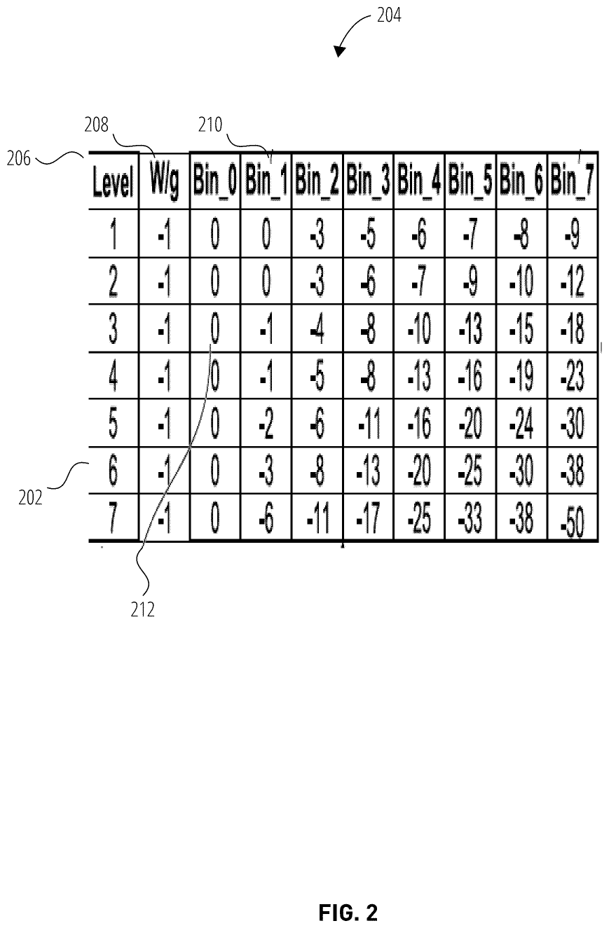

For example, the BFEA table 202 shown in FIG. 2 illustrates how read operations are managed using multiple levels 206 and WLGs 208 to determine appropriate read threshold voltage offsets. At the most basic level, the table contains a series of bins 210 (labeled Bin_0 through Bin_7) that correspond to different sets of read threshold offsets 212. These bins are organized in relation to different levels, allowing the memory sub-system controller 115 to manage read operations across various memory states.

The table structure includes seven distinct levels, with each level having its own WLG value and corresponding bin assignments. This organization enables precise control over read threshold voltage offsets based on the specific characteristics of different memory regions. When performing read operations, the memory sub-system controller 115 starts with Bin_0, which represents the initial calibration state. As charge loss occurs over time, blocks transition to higher numbered bins, with each successive bin corresponding to larger read threshold voltage offsets.

The numerical values within each bin represent specific voltage offset adjustments. These values are carefully calibrated to optimize bit error rate performance across different memory conditions and states. The offsets are used to increase/decrease the threshold voltage applied to read data from an individual portion of the memory device 130 (e.g., an individual cell, WL, WLG, and/or VB). Each level in the table corresponds to different memory states or conditions, with Level 1 through Level 7 providing increasingly larger offset values to compensate for various degrees of charge loss and read disturb effects, such as in TLC memory. The WLG column in the table indicates specific word line groupings, helping the memory sub-system controller 115 manage read operations across different physical locations within the memory device 130. The progression from Bin_0 through Bin_7 represents increasingly aggressive read threshold voltage offsets, with each bin containing specific offset values optimized for different stages of memory cell aging and charge loss.

Referring back to FIG. 1, the memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some examples, the local memory 119 can include memory registers storing memory pointers, fetched data, and so forth. The local memory 119 can also include ROM for storing micro-code. While the example memory sub-system 110 in FIG. 1 has been illustrated as including the memory sub-system controller 115, in another example, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device 130 and/or the memory device 140. The memory sub-system controller 115 can be responsible for other operations such as wear leveling operations, GC operations, error detection and ECC operations, encryption operations, caching operations, and address translations between a logical address (e.g., LBA, namespace) and a physical memory address (e.g., physical block address in a physical address space of the memory device 130 or memory device 140) that are associated with the memory devices 130, 140. The memory sub-system controller 115 can further include host interface circuitry to communicate with the host system 120 via the physical host interface. The host interface circuitry can convert the commands received from the host system 120 into command instructions to access the memory device 130 and/or the memory device 140 as well as convert responses associated with the memory device 130 and/or the memory device 140 into information for the host system 120.

The memory sub-system 110 can also include additional circuitry or components that are not illustrated. In some examples, the memory sub-system 110 can include a cache or buffer (e.g., DRAM) and address circuitry (e.g., a row decoder and a column decoder) that can receive an address from the memory sub-system controller 115 and decode the address to access the memory devices 130, 140.

In some examples, the memory device 130 includes local media controllers 135 that operate in conjunction with memory sub-system controller 115 to execute operations on one or more memory cells of the memory device 130. An external controller (e.g., memory sub-system controller 115) can externally manage the memory device 130 (e.g., perform media management operations on the memory device 130). In some examples, a memory device 130 is a managed memory device, which is a raw memory device combined with a local controller (e.g., local media controller 135) for media management within the same memory device package. An example of a managed memory device is a managed NAND (mNAND) device. Any operation discussed as being performed by the memory sub-system controller 115 can be similarly performed by the local media controllers 135 and vice versa.

The memory sub-system controller 115 includes an RDH component 113 that enables intelligent bin calibration and RD handling for memory operations. The RDH component 113 works with the memory sub-system controller 115 to implement dynamic tracking and management of read disturb effects in memory devices 130.

The RDH component 113 monitors when a read count (RC) threshold is reached for a portion of the memory device 130. Namely, the RDH component 113 can increment a RC for the VB or portion each time the portion is read. The RDH component 113 can compare that current RC value of the VB or portion to the RC threshold. In response to determining that the RC threshold is exceeded or reached, the RDH component 113 initiates RDH operations on the portion, such as by performing RD scans on the portion. Upon reaching this threshold, as part of performing the RD scan operation, the RDH component 113 compares the current bin assignment with a target bin specified in a predefined table of bin assignments. The RDH component 113 then selectively performs bin calibration operations to adjust the read threshold voltage offset based on this comparison. For example, if the current bin assignment is lower than the target bin specified in the predefined table, the RDH component 113 adjusts the read threshold voltage offset.

In some cases, for the initial RD scan, the RDH component 113 uses conservative bin assignments based on HTDR characteristics. If this first RD scan results in an RBER that exceeds the RBER threshold, the RDH component 113 performs a second RD scan using more aggressive bin assignments based on EPRD characteristics before initiating any refresh operations. The RDH component 113 obtains the appropriate read threshold offsets from the BFEA table 202 based on the adjusted bin assignments. This intelligent calibration approach helps prevent unnecessary refresh operations by ensuring optimal read threshold voltage offsets are used during the RD scan operations.

Any discussion with respect to the memory device 130 can similarly be applied to the memory device 140.

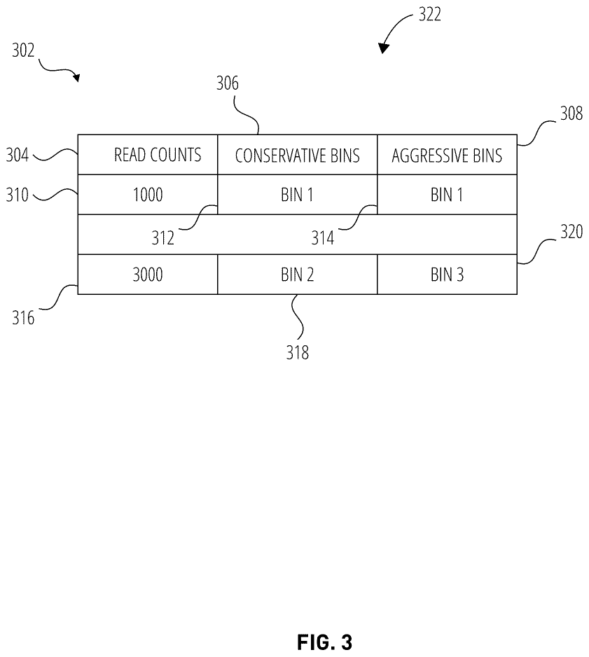

FIG. 3 illustrates a diagram 322 of a table of target bins based on read count and temperature, in accordance with some examples. Specifically, the RDH component 113 can monitor read operations on portions of the memory device 130, tracking the RC for each VB or portion. When the RC for an individual VB reaches a threshold, the RDH component 113 can initiate RDH operations.

As shown in FIG. 3, diagram 322 illustrates how the RDH component 113 manages bin calibration using read counts 304 and corresponding target bins, such as conservative bins 306 and aggressive bins 308. The RDH component 113, in response to determining that the RC for the individual VB has transgressed the threshold RC, obtains a current bin assignment for the portion (e.g., individual VB) being read. For example, the RDH component 113 accesses data associated with the VB being read to obtain the current BFEA bin assigned to the individual VB. The RDH component 113 then compares this current bin assignment against target bins specified in a predefined table, such as a bin calibration table for first temperature range 302.

The bin calibration table for first temperature range 302 includes conservative bins 306 and aggressive bins 308 associated with different RC thresholds. For example, at read count 310 of 1000, the bin calibration table for first temperature range 302 associates the read count 310 with the conservative bin (e.g., bin 1 312) and the aggressive bin (e.g., bin 1 314). At read count 316 of 3000, the bin calibration table for first temperature range 302 associates the read count 316 with the conservative bin (e.g., bin 2 318) and the aggressive bin (e.g., bin 3 320).

In some examples, the RDH component 113 first collects the current RC and temperature data for the portion (e.g., the individual VB) being read. Based on the current temperature, the RDH component 113 selects the appropriate bin calibration table for first temperature range 302 from multiple available tables, where each table is associated with a different temperature range. Within the selected table, the RDH component 113 accesses both the conservative bins 306 and aggressive bins 308 that correspond to the current RC count of the portion being read. For example, at read count 310 of 1000, the RDH component 113 can reference both conservative bin 312 (Bin 1) and aggressive bin 314 (Bin 1), while at read count 316 of 3000, the RDH component 113 can reference conservative bin 318 (Bin 2) and aggressive bin 320 (Bin 3).

The RDH component 113 then compares the current bin assignment for the individual VB against these target bin values. If either the conservative or aggressive target bin has a higher numerical value than the current bin assignment, the RDH component 113 obtains new read threshold offsets from the BFEA table 202 corresponding to the higher target bin level. The higher numerical bin values correspond to larger read threshold voltage offsets that compensate for increased charge loss over time. The RDH component 113 can then perform the RD scan or other RDH operations on the portion of the memory device 130 using the read threshold voltage offsets associated with the higher numerical bin. If neither the conservative or aggressive target bin has a higher numerical value than the current bin assignment, the RDH component 113 can then perform the RD scan or other RDH operations on the portion of the memory device 130 using the read threshold voltage offsets associated with the currently assigned BFEA table 202 bin.

For example, the current bin assignment for the individual VB can be Bin_0 and the read count reaches 3000 at Level 3. According to the bin calibration table for first temperature range 302, the conservative target bin can be Bin_2 (318) and the aggressive target bin can be Bin_3 (320). Since both target bins have higher numerical values than the current Bin_0 assignment, the RDH component 113 can obtain new read threshold offsets from the BFEA table 202. For Level 3 in the BFEA table, the current Bin_0 offset value is 0, while the conservative Bin_2 offset value is 4, and the aggressive Bin_3 offset value is 8. For the initial RD scan using conservative bin calibration, the RDH component 113 can adjust from the current offset of 0 to the Bin_2 offset value of 4. If the resulting RBER exceeds the threshold, the RDH component 113 can perform a second RD scan using the more aggressive Bin_3 offset value of 8. This progression from lower to higher offset values demonstrates how the system compensates for increased charge loss over time. The larger offset values in higher-numbered bins (like the value 8 in Bin_3 compared to 4 in Bin_2) provide more aggressive voltage adjustments to handle read disturb effects. If the current bin assignment had already been Bin_2 or higher, and this exceeded both the conservative and aggressive target bins from bin calibration table for first temperature range 302, the RDH component 113 can continue using the current bin's offset values from the BFEA table 202 without adjustment.

In some examples, the RDH component 113 can implement different strategies for bin calibration. In some cases, the RDH component 113 uses conservative bin assignments based on HTDR characteristics before performing initial RD scans. In other cases, the RDH component 113 uses more aggressive bin assignments based on EPRD characteristics, particularly before refresh operations.

For multiple RD scan implementations, the RDH component 113 employs a sophisticated two-stage approach using different read threshold voltage offsets. In the first stage, the RDH component 113 performs a RD scan using conservative bin assignments based on HTDR characteristics. These conservative bins can specify lower numerical values for read threshold voltage offsets to maintain stable operation. When performing the first RD scan, the RDH component 113 adjusts the current bin assignment for the individual VB based on the conservative bin assignment associated with the current read count and temperature data in the bin calibration table for first temperature range 302. This is the case if the current bin assignment is of a lower value or lower bin value than the value specified in the bin calibration table for first temperature range 302 for the conservative bins 306. The RDH component 113 then obtains a set of read threshold offsets from the BFEA table 202 based on this adjusted conservative bin assignment. For example, at a read count of 3000, it can use bin 2 from the conservative bins, which corresponds to specific voltage offset values in the BFEA table 202 instead of a currently assigned bin 1.

If the RBER resulting from this first conservative RD scan exceeds the RBER threshold, rather than immediately triggering a refresh operation, the RDH component 113 performs a second RD scan using more aggressive bin assignments based on EPRD characteristics. The RDH component 113 re-adjusts the current bin assignment based on the aggressive bin assignment associated with the same read count and temperature data. For the same read count of 3000, the RDH component 113 can now use bin 3 from the aggressive bins 308, obtaining a different set of read threshold offsets from the BFEA table 202 rather than bin 1 or bin 2. If the RBER still transgresses the RBER threshold after the second RD scan, the RDH component 113 can trigger the refresh operations to be performed for the individual VB. If the RBER fails to be transgressed after the second RD scan, the RDH component 113 skips performing the refresh operations and, optionally, updates the current bin assigned to the VB so that future or subsequent reads to the VB are performed using the read threshold voltage offsets associated with the aggressive bins 308.

This progressive approach from conservative to aggressive threshold voltages allows the system to first attempt read operations with safer voltage levels that minimize potential disturbance to the cells, while maintaining the option to use more aggressive voltage levels if needed. The system only proceeds with refresh operations if the RBER still exceeds the threshold even with the aggressive bin assignments, helping to prevent unnecessary refresh operations that could impact the TBW specification. The use of both conservative and aggressive threshold voltages is particularly important in 3D NAND devices, where read disturb effects can occur due to complex voltage interactions between word lines. The conservative voltages help maintain data retention characteristics, while the aggressive voltages can better handle every page read disturb effects that occur during sequential reading across word lines.

Multiple instances of the bin calibration table for first temperature range 302 can be provided, with each instance associated with a different temperature range. The RDH component 113 determines the current temperature of the memory device 130 and selects the appropriate table instance based on this temperature. This temperature-aware selection ensures that bin calibration accounts for both read count and temperature effects on the memory cells.

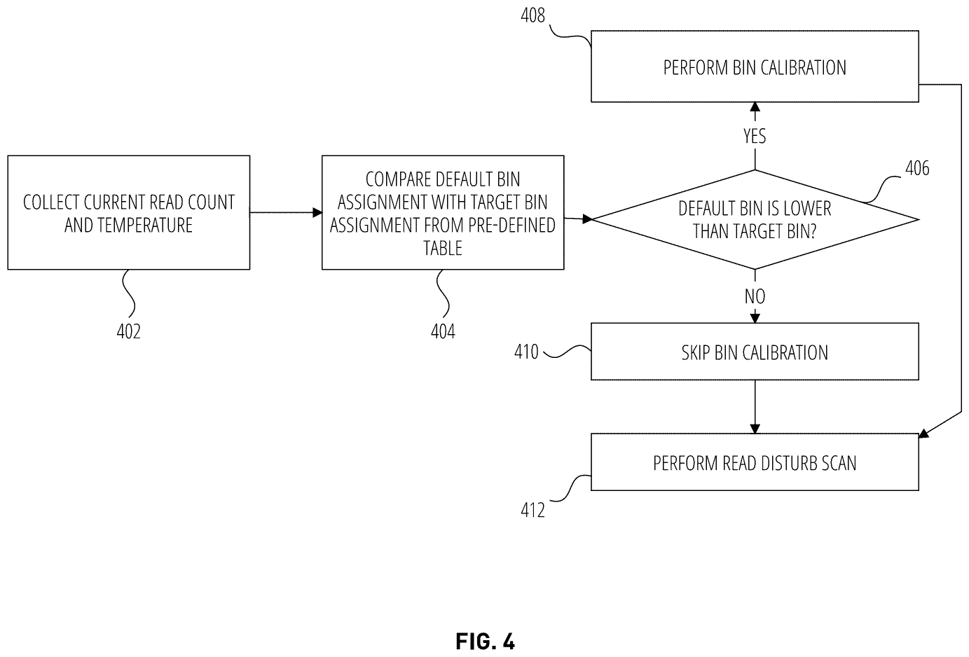

FIG. 4 is a flow diagram of an example routine (method or process) performed using the RDH component 113, in accordance with some examples. The method or process of the diagram shown in FIG. 4 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method or process is performed by the memory sub-system controller 115 or subcomponents of the memory sub-system controller 115 of FIG. 1. In these examples, the method or process can be performed, at least in part, by the RDH component 113. Although the processes are shown in a particular sequence or order, unless otherwise specified, the order of the processes can be modified. Thus, the illustrated examples should be understood only as examples; the illustrated processes can be performed in a different order, and some processes can be performed in parallel. Additionally, one or more processes can be omitted in various examples. Thus, not all processes are required in every example. Other process flows are possible.

Referring to FIG. 4, the process begins at operation 402 where the RDH component 113 collects the current read count and temperature data for the portion being read. The RDH component 113 then proceeds to operation 406 where the RDH component 113 compares the default (current) BFEA bin assignment with the target bin assignment specified in a pre-defined table, such as the bin calibration table for first temperature range 302.

At operation 406, the RDH component 113 determines if the default bin is lower than the target bin. If the default bin is lower than the target bin specified in the table, the process proceeds to perform bin calibration at operation 408. If the default bin is not lower, the process proceeds to operation 410 to skip bin calibration. After either performing or skipping bin calibration, the process moves to operation 412 where the RDH component 113 performs a RD scan on the portion of the memory device using either the calibrated bin assignment or the original default bin assignment, depending on the previous determination.

The illustrated process provides a flexible framework where the order of operations can be modified, processes can be performed in parallel, and certain operations may be omitted in various implementations. This allows the system to optimize the bin calibration process based on specific memory device requirements and operating conditions.

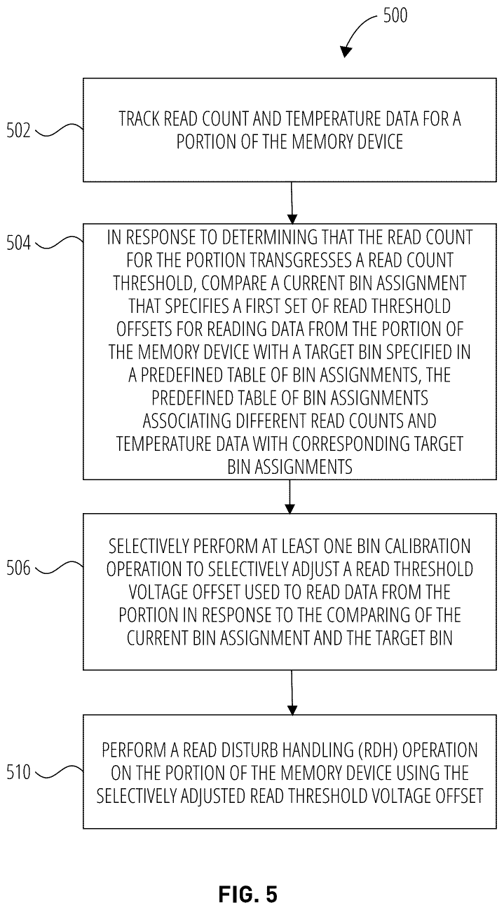

FIG. 5 illustrates a flow diagram 500 showing operations performed by the RDH component 113. The process can be implemented through various forms of processing logic, including hardware components (such as processing devices, dedicated logic circuits, programmable logic, microcode, or integrated circuits), software instructions executed on a processing device, or combinations thereof. The memory sub-system controller 115 or its subcomponents can perform these operations, with the RDH component 113 handling key aspects of the process.

The flow diagram 500 begins at operation 502, where the RDH component 113 tracks read count and temperature data for a portion of the memory device 130. This tracking operation enables the system to monitor usage patterns and thermal conditions that affect memory cell behavior. At operation 504, the RDH component 113, in response to determining that the RC for the portion has reached a threshold, compares the current bin assignment with a target bin specified in a predefined table of bin assignments, such as the bin calibration table for first temperature range 302. This bin calibration table for first temperature range 302 associates different read counts and temperature data with corresponding target bin assignments.

Operation 506 involves the RDH component 113 selectively performing bin calibration operations to adjust read threshold voltage offsets based on the comparison results. If the current bin assignment is lower than the target bin, the RDH component 113 obtains new threshold offsets from the BFEA table. Finally, at operation 510, the RDH component 113 performs a RDH operation on the portion of the memory device using the selectively adjusted read threshold voltage offset. This may include performing read disturb scans with either conservative or aggressive bin assignments depending on the specific circumstances.

The process flow allows for flexible implementation, where operations can be performed in different orders or in parallel as needed. Some operations may be omitted in certain implementations based on specific memory device requirements and operating conditions.

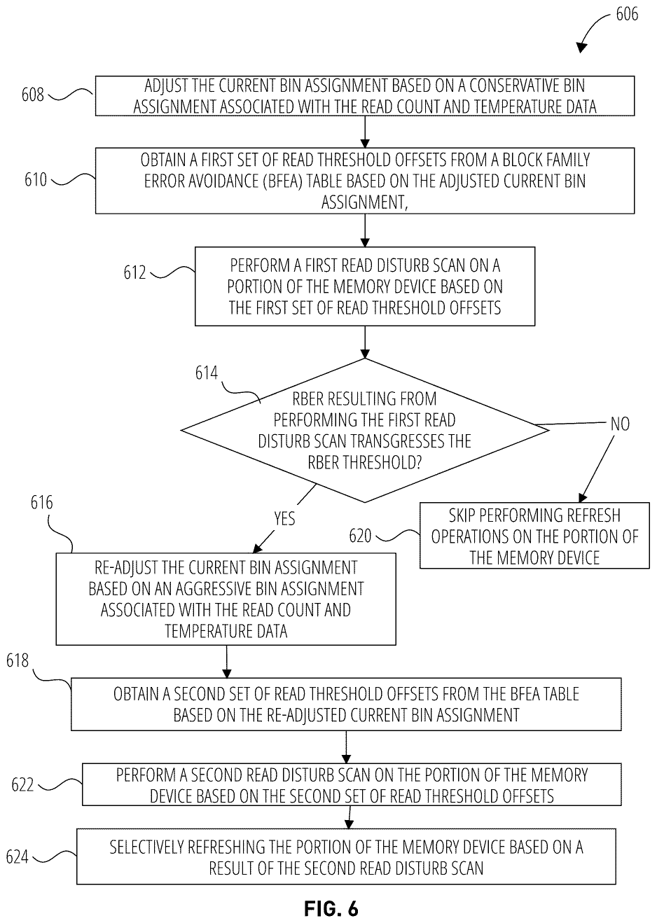

FIG. 6 illustrates a flow diagram 606 showing operations performed by the RDH component 113. The process can be implemented through various forms of processing logic, including hardware components (such as processing devices, dedicated logic circuits, programmable logic, microcode, or integrated circuits), software instructions executed on a processing device, or combinations thereof. The memory sub-system controller 115 or its subcomponents can perform these operations, with the RDH component 113 handling key aspects of the process.

The flow diagram 606 begins at operation 608, where the RDH component 113 adjusts the current bin assignment based on a conservative bin assignment associated with the RC and temperature data. The operation 608 can be performed in response to determining that the current RC count for the portion of the memory device 130 (e.g., VB) being read transgresses an RC threshold. The RDH component 113 then obtains a first set of read threshold offsets from the BFEA table 202 based on the adjusted current bin assignment at operation 610.

At operation 612, the RDH component 113 performs a first RD scan on a portion of the memory device 130 based on the first set of read threshold offsets. The process then moves to operation 614, where the RDH component 113 determines whether the RBER resulting from performing the first RD scan transgresses the RBER threshold. If the RBER threshold is not exceeded at operation 614, the process proceeds to operation 620 where the RDH component 113 skips performing refresh operations on the portion of the memory device 130. However, if the threshold is exceeded, the process continues to operation 616 where the RDH component 113 re-adjusts the current bin assignment based on an aggressive bin assignment associated with the read count and temperature data.

At operation 618, the RDH component 113 obtains a second set of read threshold offsets from the BFEA table 202 based on the re-adjusted current bin assignment and, at operation 622, performs a second RD scan on the portion of the memory device 130 using these new offsets. Finally, at operation 624, the RDH component 113 selectively refreshes the portion of the memory device based on the result of the second read disturb scan. Specifically, if the RBER resulting from the second read disturb scan transgresses the RBER threshold, the RDH component 113 proceeds with refreshing the portion of the memory device. However, if the RBER from the second RD scan does not exceed the RBER threshold, the RDH component 113 skips performing the refresh operation, thereby preventing unnecessary refresh operations that could impact the TBW specification. Alternatively, if the RBER from the second RD scan exceeds the RBER threshold, the RDH component 113 performs the refresh operation for the portion of the memory device 130.

This two-stage approach using both conservative and aggressive bin assignments helps prevent unnecessary refresh operations while maintaining optimal read threshold voltage offsets for different memory conditions.

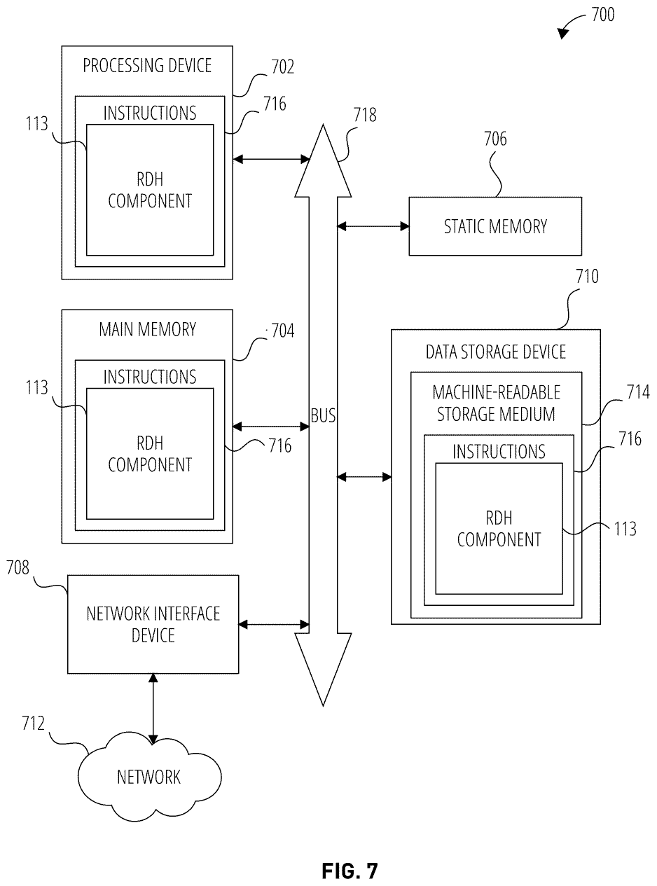

FIG. 7 illustrates an example machine in the form of a computer system 700 within which a set of instructions can be executed for causing the machine to perform any one or more of the methodologies discussed herein. In some examples, the computer system 700 can correspond to a host system (e.g., the host system 120 of FIG. 1) that includes, is coupled to, or utilizes a memory sub-system (e.g., the memory sub-system 110 of FIG. 1) or can be used to perform the operations described herein. In alternative examples, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., ROM, flash memory, DRAM such as SDRAM or Rambus DRAM (RDRAM), etc.), a static memory 706 (e.g., flash memory, static random access memory (SRAM), etc.), and a data storage device 710, which communicate with each other via a bus 718.

The processing device 702 represents one or more general-purpose processing devices such as a microprocessor, a central processing unit, or the like. More particularly, the processing device 702 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 702 can also be one or more special-purpose processing devices such as an application-specific integrated circuit (ASIC), a field programmable gate array (FPGA), a digital signal processor (DSP), a network processor, or the like. The processing device 702 is configured to execute instructions 716 for performing the operations and steps discussed herein. The computer system 700 can further include a network interface device 708 to communicate over a network 712.

The data storage device 710 can include a machine-readable storage medium 714 (also known as a computer-readable medium) on which is stored one or more sets of instructions 716 or software embodying any one or more of the methodologies or functions described herein. The instructions 716 can also reside, completely or at least partially, within the main memory 704 and/or within the processing device 702 during execution thereof by the computer system 700, the main memory 704 and the processing device 702 also constituting machine-readable storage media. The machine-readable storage medium 714, data storage device 710, and/or main memory 704 can correspond to the memory sub-system 110 of FIG. 1.

In one example, the instructions 716 include instructions to implement functionality corresponding to providing block failure protection for a zone memory sub-system as described herein (e.g., the RDH component 113 of FIG. 1). While the machine-readable storage medium 714 is shown in an example to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Described implementations of the subject matter can include one or more features, alone or in combination as illustrated below by way of examples.

Example 1. A system comprising: a memory device; and a processing device, operatively coupled to the memory device, configured to perform operations comprising: tracking read count and temperature data for a portion of the memory device; in response to determining that the read count for the portion transgresses a read count threshold, comparing a current bin assignment that specifies a first set of read threshold offsets for reading data from the portion of the memory device with a target bin specified in a predefined table of bin assignments, the predefined table of bin assignments associating different read counts and temperature data with corresponding target bin assignments; selectively performing at least one bin calibration operation to selectively adjust a read threshold voltage offset used to read data from the portion in response to the comparing of the current bin assignment and the target bin; and performing a RDH operation on the portion of the memory device using the selectively adjusted read threshold voltage offset.

Example 2. The system of Example 1, wherein the portion comprises a memory block or virtual block (VB).

Example 3. The system of Example 2, wherein performing the RDH operation comprises performing an RD scan for determining whether raw bit error rates (RBER) for the portion of the memory device exceeds an RBER threshold.

Example 4. The system of Example 3, the operations comprising: refreshing data in the portion of the memory device in response to determining that the RBER transgresses the RBER threshold.

Example 5. The system of any one of Examples 1-4, wherein the current bin assignment is retrieved from a block family error avoidance (BFEA) table.

Example 6. The system of any one of Examples 1-5, wherein the predefined table of bin assignments comprises: a first set of conservative bin assignments based on high temperature data retention (HTDR) characteristics; and a second set of aggressive bin assignments based on every page read disturb (EPRD) characteristics.

Example 7. The system of Example 6, wherein the at least one bin calibration operation uses the first set of conservative bin assignments when performed before a read disturb scan operation.

Example 8. The system of any one of Examples 6-7, wherein the at least one bin calibration operation uses the second set of aggressive bin assignments when performed after a read disturb scan operation and before performing a refresh operation.

Example 9. The system of any one of Examples 1-8, wherein performing the RDH operation comprises: performing a first read disturb scan using a first calibrated bin assignment; and performing a second read disturb scan using a second calibrated bin assignment when a raw bit error rate (RBER) from the first read disturb scan exceeds an RBER threshold.

Example 10. The system of Example 9, wherein performing the first read disturb scan comprises: adjusting the current bin assignment based on a conservative bin assignment associated with the read count and temperature data; and obtaining a second set of read threshold offsets from a block family error avoidance (BFEA) table based on the adjusted current bin assignment, wherein the first read disturb scan is performed on the portion of the memory device based on the second set of read threshold offsets.

Example 11. The system of Example 10, the operations comprising: determining that the RBER resulting from performing the first read disturb scan transgresses the RBER threshold; prior to refreshing the portion of the memory device, re-adjusting the current bin assignment based on an aggressive bin assignment associated with the read count and temperature data; obtaining a third set of read threshold offsets from the BFEA table based on the re-adjusted current bin assignment, wherein the second read disturb scan is performed on the portion of the memory device based on the third set of read threshold offsets; and selectively refreshing the portion of the memory device based on a result of performing the second read disturb scan.

Example 12. The system of Example 11, the operations comprising: determining that the RBER resulting from performing the second read disturb scan transgresses the RBER threshold; and in response to determining that the RBER resulting from performing the second read disturb scan transgresses the RBER threshold, refreshing the portion of the memory device.

Example 13. The system of any one of Examples 1-12, wherein the at least one bin calibration operation is performed at one or more of: before a read disturb scan operation and before a refresh operation.

Example 14. The system of any one of Examples 1-13, wherein the read threshold voltage offset is adjusted in response to determining that the current bin assignment is lower than the target bin specified in the predefined table of bin assignments.

Example 15. The system of Example 14, the operations comprising: determining that the current bin assignment has a lower numerical value than the target bin specified in the predefined table of bin assignments, wherein a higher numerical bin value corresponds to a larger read threshold voltage offset to compensate for increased charge loss over time.

Example 16. The system of any one of Examples 1-15, wherein the memory device comprises a three-dimensional (3D) NAND device.

Example 17. At least one non-transitory machine-readable storage medium comprising instructions that, when executed by a processing device, cause the processing device to perform operations comprising: tracking read count and temperature data for a portion of a memory device; in response to determining that the read count for the portion transgresses a read count threshold, comparing a current bin assignment that specifies a first set of read threshold offsets for reading data from the portion of the memory device with a target bin specified in a predefined table of bin assignments, the predefined table of bin assignments associating different read counts and temperature data with corresponding target bin assignments; selectively performing at least one bin calibration operation to selectively adjust a read threshold voltage offset used to read data from the portion in response to the comparing of the current bin assignment and the target bin; and performing a RDH operation on the portion of the memory device using the selectively adjusted read threshold voltage offset.

Example 18. A method comprising: tracking read count and temperature data for a portion of a memory device; in response to determining that the read count for the portion transgresses a read count threshold, comparing a current bin assignment that specifies a first set of read threshold offsets for reading data from the portion of the memory device with a target bin specified in a predefined table of bin assignments, the predefined table of bin assignments associating different read counts and temperature data with corresponding target bin assignments; selectively performing at least one bin calibration operation to selectively adjust a read threshold voltage offset used to read data from the portion in response to the comparing of the current bin assignment and the target bin; and performing a RDH operation on the portion of the memory device using the selectively adjusted read threshold voltage offset.

Example 19. The method of Example 18, wherein the portion comprises a memory block or virtual block (VB).

Example 20. The method of Example 19, wherein performing the RDH operation comprises performing an RD scan for determining whether raw bit error rates (RBER) for the portion of the memory device exceeds an RBER threshold.

The term “coupled with” generally refers to a connection between components, which can be an indirect communicative connection or direct communicative connection (e.g., without intervening components), whether wired or wireless, including connections such as electrical, optical, magnetic, and the like. “System data” hereinafter refers to data that is created and/or maintained by the memory sub-system for performing operations in response to host requests and for media management. “User data” hereinafter generally refers to host data and garbage collection data. “Read disturb” refers to a phenomenon where repeated read operations on a specific WL in a NAND flash memory block cause unintended changes in the threshold voltages of adjacent cells on unselected WLs within the same block. This effect can potentially lead to data corruption in neighboring cells if left unmanaged, necessitating periodic data refresh or block relocation (folding) operations to maintain data integrity in NAND-based storage devices. “Folding” refers to an operation where data from multiple partially filled pages or blocks is combined and rewritten into new pages or new blocks, respectively. This process helps to optimize storage space utilization, reduce write amplification, and improve overall performance of the NAND storage device by consolidating fragmented data and freeing up space for new writes. Folding and “relocation” operations are used interchangeably and mean the same thing. “High-risk WLs” or “mandatory WLs” refer to WLs within a NAND flash memory block that are more susceptible to data corruption or errors due to various factors, such as frequent read operations, physical location within the block, and/or proximity to heavily accessed areas. These WLs can require more frequent monitoring, error checking, and potential data refresh or relocation operations to maintain data integrity and overall reliability of the NAND storage device. These WLs can be predetermined and stored as part of configuration data of the memory sub-system. “Virtual blocks (VB)” represent a logical grouping of memory cells in the memory device that is read at the same time. The VB can include multiple memory blocks that span across multiple memory dies. “BFEA” refers to a sophisticated technique used to enhance the reliability and performance of NAND-based storage devices, particularly in solid-state drives (SSDs). BFEA (block family error avoidance) involves grouping or categorizing blocks with similar error characteristics to optimize error management strategies. In NAND flash memory, blocks can develop varying error rates over time due to factors such as wear, manufacturing variations, and environmental conditions. The block family error avoidance bin strategy addresses this by monitoring and analyzing the error rates of individual blocks, then grouping blocks with similar error profiles into “families” or “bins.” Once categorized, specific error management techniques are applied to each bin based on its unique error characteristics. This approach allows the memory controller to optimize error correction code (ECC) strategies, adjust read voltage thresholds more effectively, implement targeted wear-leveling algorithms, and prioritize blocks for garbage collection or retirement based on their error bin.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium (such as a non-transitory machine-readable medium) having stored thereon instructions, which can be used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine (e.g., a computer) readable storage medium such as a ROM, RAM, magnetic disk storage media, optical storage media, flash memory components, and so forth. A machine-readable storage medium can be non-transitory (in other words, not having any transitory signals) in that it does not embody a propagating signal. However, labeling a machine-readable storage medium “non-transitory” should not be construed to mean that the machine-readable storage medium is incapable of movement; the machine-readable storage medium should be considered as being transportable from one physical location to another.

In the foregoing specification, examples of the disclosure have been described with reference to specific examples thereof. It will be evident that various modifications can be made thereto without departing from the broader scope of examples of the disclosure as set forth in the following claims. The specification and drawings are, accordingly, to be regarded in an illustrative sense rather than a restrictive sense.

1. A system comprising:
a memory device; and
a processing device, operatively coupled to the memory device, configured to perform operations comprising:
tracking read count and temperature data for a portion of the memory device;
in response to determining that the read count for the portion transgresses a read count threshold, comparing a current bin assignment that specifies a first set of read threshold offsets for reading data from the portion of the memory device with a target bin specified in a predefined table of bin assignments, the predefined table of bin assignments associating different read counts and temperature data with corresponding target bin assignments;
selectively performing at least one bin calibration operation to selectively adjust a read threshold voltage offset used to read data from the portion in response to the comparing of the current bin assignment and the target bin; and
performing a read disturb handling (RDH) operation on the portion of the memory device using the selectively adjusted read threshold voltage offset.

2. The system of claim 1, wherein the portion comprises a memory block or virtual block (VB).

3. The system of claim 2, wherein performing the RDH operation comprises performing an RD scan for determining whether raw bit error rates (RBER) for the portion of the memory device exceeds an RBER threshold.

4. The system of claim 3, the operations comprising:
refreshing data in the portion of the memory device in response to determining that the RBER transgresses the RBER threshold.

5. The system of claim 1, wherein the current bin assignment is retrieved from a block family error avoidance (BFEA) table.

6. The system of claim 1, wherein the predefined table of bin assignments comprises:
a first set of conservative bin assignments based on high temperature data retention (HTDR) characteristics; and
a second set of aggressive bin assignments based on every page read disturb (EPRD) characteristics.

7. The system of claim 6, wherein the at least one bin calibration operation uses the first set of conservative bin assignments when performed before a read disturb scan operation.

8. The system of claim 6, wherein the at least one bin calibration operation uses the second set of aggressive bin assignments when performed after a read disturb scan operation and before performing a refresh operation.

9. The system of claim 1, wherein performing the RDH operation comprises:
performing a first read disturb scan using a first calibrated bin assignment; and
performing a second read disturb scan using a second calibrated bin assignment when a raw bit error rate (RBER) from the first read disturb scan exceeds an RBER threshold.

10. The system of claim 9, wherein performing the first read disturb scan comprises:
adjusting the current bin assignment based on a conservative bin assignment associated with the read count and temperature data; and
obtaining a second set of read threshold offsets from a block family error avoidance (BFEA) table based on the adjusted current bin assignment, wherein the first read disturb scan is performed on the portion of the memory device based on the second set of read threshold offsets.

11. The system of claim 10, the operations comprising:
determining that the RBER resulting from performing the first read disturb scan transgresses the RBER threshold;
prior to refreshing the portion of the memory device, re-adjusting the current bin assignment based on an aggressive bin assignment associated with the read count and temperature data;
obtaining a third set of read threshold offsets from the BFEA table based on the re-adjusted current bin assignment, wherein the second read disturb scan is performed on the portion of the memory device based on the third set of read threshold offsets; and
selectively refreshing the portion of the memory device based on a result of performing the second read disturb scan.

12. The system of claim 11, the operations comprising:
determining that the RBER resulting from performing the second read disturb scan transgresses the RBER threshold; and
in response to determining that the RBER resulting from performing the second read disturb scan transgresses the RBER threshold, refreshing the portion of the memory device.

13. The system of claim 1, wherein the at least one bin calibration operation is performed at one or more of: before a read disturb scan operation and before a refresh operation.

14. The system of claim 1, wherein the read threshold voltage offset is adjusted in response to determining that the current bin assignment is lower than the target bin specified in the predefined table of bin assignments.

15. The system of claim 14, the operations comprising:
determining that the current bin assignment has a lower numerical value than the target bin specified in the predefined table of bin assignments, wherein a higher numerical bin value corresponds to a larger read threshold voltage offset to compensate for increased charge loss over time.

16. The system of claim 1, wherein the memory device comprises a three-dimensional (3D) NAND device.

17. At least one non-transitory machine-readable storage medium comprising instructions that, when executed by a processing device, cause the processing device to perform operations comprising:
tracking read count and temperature data for a portion of a memory device;
in response to determining that the read count for the portion transgresses a read count threshold, comparing a current bin assignment that specifies a first set of read threshold offsets for reading data from the portion of the memory device with a target bin specified in a predefined table of bin assignments, the predefined table of bin assignments associating different read counts and temperature data with corresponding target bin assignments;
selectively performing at least one bin calibration operation to selectively adjust a read threshold voltage offset used to read data from the portion in response to the comparing of the current bin assignment and the target bin; and
performing a read disturb handling (RDH) operation on the portion of the memory device using the selectively adjusted read threshold voltage offset.

18. A method comprising:
tracking read count and temperature data for a portion of a memory device;
in response to determining that the read count for the portion transgresses a read count threshold, comparing a current bin assignment that specifies a first set of read threshold offsets for reading data from the portion of the memory device with a target bin specified in a predefined table of bin assignments, the predefined table of bin assignments associating different read counts and temperature data with corresponding target bin assignments;
selectively performing at least one bin calibration operation to selectively adjust a read threshold voltage offset used to read data from the portion in response to the comparing of the current bin assignment and the target bin; and
performing a read disturb handling (RDH) operation on the portion of the memory device using the selectively adjusted read threshold voltage offset.

19. The method of claim 18, wherein the portion comprises a memory block or virtual block (VB).

20. The method of claim 19, wherein performing the RDH operation comprises performing an RD scan for determining whether raw bit error rates (RBER) for the portion of the memory device exceeds an RBER threshold.
